(19) United States
(12) Patent Application Publication
(10) Pub. No.: US 2011/0051557 A1
(43) Pub. Date: Mar. 3, 2011

(54) Apparatus and Method for Control Using a Humming Frequency

(76) Inventors: Nathalia Peixoto, Ashburn, VA (US); Gregory Gutt, Ashburn, VA (US); Hossein Ghaffari Nik, Burke, VA (US)

(21) Appl. No.: 12/547,599

(22) Filed: Aug. 26, 2009

(51) Int. Cl. G10K 11/00; G10L 21/00

(52) U.S. Cl. 367/198; 704/275; 704/E21.001

(57) ABSTRACT

A device controller configured to control physical devices using an audible humming frequency that includes: a humming frequency module, a humming command module, and a control command module. The humming frequency module may be configured to determine humming frequenc(ies) using a detected humming signal(s). The humming command module may be configured to compute humming command(s) based on the humming frequenc(ies). The control command module may be configured to generate control command(s) using received key command(s) and humming command(s).

### BRIEF DESCRIPTION OF THE SEVERAL VIEWS OF THE DRAWINGS

The accompanying drawings, which are included to provide a further understanding of the invention, are incorporated in and constitute a part of this specification; illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 shows a general system controlled by the frequency of a hum, according to one embodiment.

FIG. 2 shows a method by which the frequency of a hum can control a system, according to one embodiment.

FIG. 3 shows a system for control of a wheel chair employing speech control and frequency of humming control, according to one embodiment.

FIG. 4 shows a method for controlling a wheel chair using speech control and the frequency of a hum, according to one embodiment.

FIG. 5 shows a system controlled by the frequency of a hum and additional command controls, according to one embodiment.

FIG. 6 shows a method of controlling a system using the frequency of a hum and additional controls, according to one embodiment.

FIG. 7 shows a system for controlling a remote control car using the frequency of a hum, according to one embodiment.

FIG. 8 shows a system controlled by the frequency of a hum, according to one embodiment.

FIG. 9 shows an apparatus for controlling a device as per an aspect of an embodiment.

FIG. 10 shows a flow diagram of a method for controlling a device as per an aspect of an embodiment.

### DETAILED DESCRIPTION OF EMBODIMENTS

Embodiments of the present invention generally relate to control of physical devices using an audible humming frequency.

The frequency of a hum can be used to control a device. The frequency can be detected and determined. A determined frequency can then be correlated to a specific command, a general command, or used for other processing means. A command correlating to the determined frequency can then be sent to a device, which can then fulfill the command.

Illustrative embodiments and applications are described below with reference to the accompanying drawings.

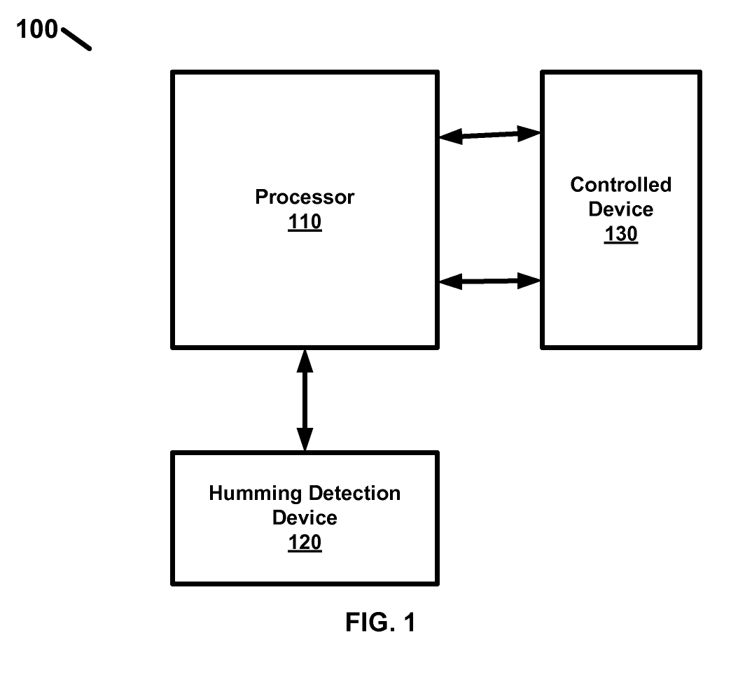

Referring now to the drawings, FIG. 1 shows a general system 100 that can be controlled by the frequency of a hum, including a processor 110, a humming detection device 120 and a controlled device 130, according to one embodiment. The processor 110 can be coupled to the humming detection device 120 and can receive digital and/or analog signals for the humming detection device 120. The processor 110 can also be coupled to the controlled device 130 and can receive and transmit digital and/or analog signals with the controlled device 130.

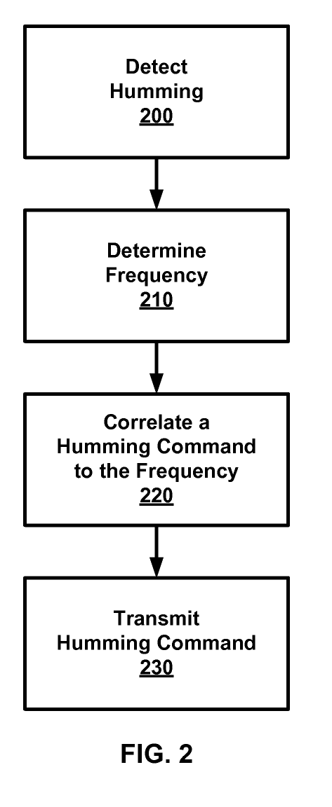

FIG. 2 shows a method by which the frequency of a hum can control a system, according to one embodiment. At 200, the humming detection device 120 can detect at least one frequency of a hum. The humming can be produced by human vocal cords. Alternatively, the humming can be produced by a machine or other device capable of producing vibrations or sound waves. The humming detection device 120 can detect at least one frequency of a hum and may transmit a digital and/or analog signal to the processor 110 that can correspond to the detected frequency. The humming detection device 120 in one embodiment can be an accelerometer. In another embodiment the humming detection device 120 may be a microphone, either dynamic or condenser type, or any other acquisition device which can measure frequency or vibration. The humming detection device 120 may require specific signal processing to detect the frequency from the special case of a humming signal versus non-humming signals that may contain frequency components.

At 210, the processor 110 can receive the signal from the humming detection device 120 and may compute the at least one frequency detected by the humming detecting device 120. At 220, the computed frequency can be used by the processor 110 to determine a humming command the processor 110 may send to the controlled device 130. At 220, the processor 110 can correlate a specific humming command to each individual frequency or to a range of frequencies. For example, the processor 110 can correlate humming command A to frequencies ranging from 50 Hz to 100 Hz and humming command B to frequencies ranging from 100 Hz to 150 Hz. The range of frequencies that can correlate to a specific humming command can be determined by an end user and can depend on the number of humming commands, sensitivity of the equipment and the full dynamic range of the humming. Further, in one embodiment, if the processor 110 at 220 determines that a frequency is out of a set range, it may not correlate the frequency to any humming command.

In another embodiment, at 220, the processor 110 can correlate a humming command to a sequence of specific frequencies or frequency ranges. For example, if a frequency between 20 and 100 Hz is received and within a set time period a frequency between 200 and 300 Hz is also received, the sequence of frequencies within those certain ranges could correlate to a specific humming command. For example, the set time period could be two seconds and if a first frequency of 50 Hz and a second frequency of 250 Hz are received within the set time period, this sequence of frequencies could correlate to a specific humming command. Further, if the first frequency was 150 Hz and the second frequency was 250 Hz and both were received with a set time period, the frequencies may not correlate to a specific humming command.

A sequence of frequencies could also include three different frequency ranges. For example, a first frequency of 50 Hz, a second frequency of 150 Hz and a third frequency of 250 Hz could all be received within a set time period and could correlate to a humming command. Further, a sequence of frequencies could include some of the same frequency ranges. For example, a first frequency of 50 Hz, a second frequency of 150 Hz and a third frequency of 50 Hz could all be received within a set time period and could correlate to a humming command.

In another embodiment, a key command may be used in addition to the humming command. Key commands may be generated in many ways including using key pads, voice recognition systems or the like. Additionally, a sequence of frequencies or a single frequency could also act as a key command that can indicate to the processor 110 that it should determine additional commands based on the incoming frequencies. For example, the processor 110 could correlate a command to a frequency with a range of 20-100 Hz if that frequency is received after a key command frequency is received. The key command frequency could be 700 Hz. The processor 110 could receive a frequency of 700 Hz and could recognize the frequency as a key command. The processor 110 could then receive a frequency of 50 Hz and could correlate that frequency with a humming command. However, if the key command frequency of 700 Hz was not received, the processor 110 could ignore the 50 Hz frequency and could send no commands to the controlled device 130. Thus, in this specific situation, the ability of the processor 110 to output commands may depend on the user's ability to generate specific frequencies that can correlate to commands.

At 230, the processor 110 can output command(s) to the controlled device 130. The commands can be digital and/or analog signals. The controlled device 130 can receive the command and can perform the command. In one embodiment, the processor 110 and controlled device 130 can operate in a closed loop system, where the controlled device 130 can send feedback data to the processor 110 based on the performance of a command that was received from the processor 110. In another embodiment, the processor 110 and the controlled device 130 can operate in an open looped system where the controlled device 130 may not send data to the processor 110. Commands may be humming commands, key commands or combinations of key and humming commands.

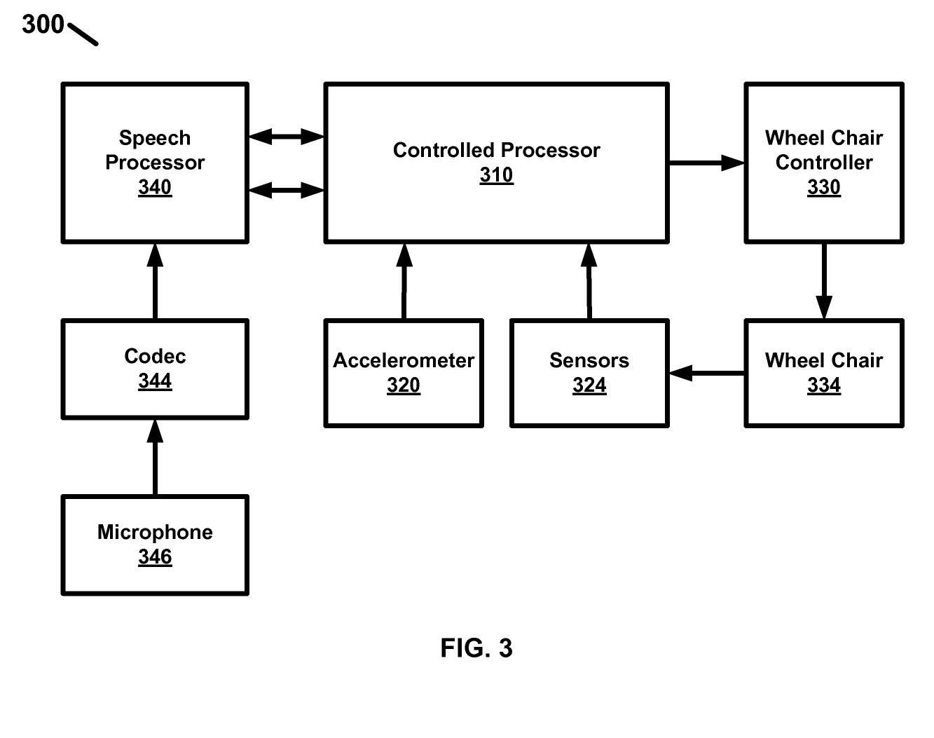

FIG. 3 shows a wheel chair system 300 that can control a wheel chair by employing speech control to generate key commands and humming frequency(ies) to generate humming commands, according to one embodiment. The wheel chair system 300 comprises a command processor 310, an accelerometer 320, sensors 324, a wheel chair controller 330, a wheel chair 334, a speech processor 340, a codec 344, and a microphone 346. The command processor 310 can be coupled to and can receive digital and/or analog signals from the accelerometer 320, the sensors 324 and the speech processor 340. The command processor 310 can be further coupled to the wheel chair controller 330 and can send digital and/or analog signals to the wheel chair controller 330 and the speech processor 340. The microphone 346 can be coupled to and can send digital and/or analog signals to the codec 344. The codec 344 can be coupled to and can send digital and/or analog signals to the speech processor 340. The wheel chair controller 330 can be coupled to the wheel chair 334 and can send digital and/or analog commands to the wheel chair 334. Further, sensors 324 can be attached to the wheel chair 334 to provide feedback to the command processor 310.

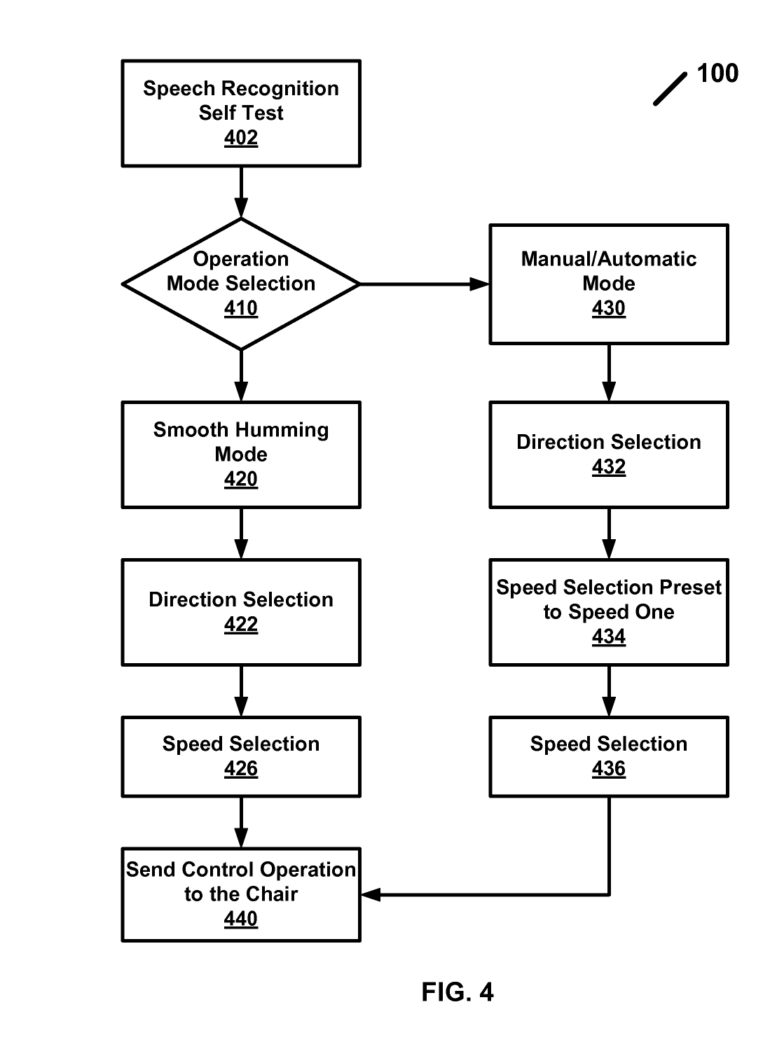

In this example, the wheel chair system 300 can control the operation of an electric wheel chair 334 through voice key commands and humming commands. The functionality of system 300 can be described with reference to FIG. 4 that shows a wheel chair command process 400 for controlling the wheel chair 334 using speech control and the frequency of a hum, according to one embodiment. At 402, the speech processor 340 can run a speech recognition self test to determine if the speech processor 340 is running correctly and is prepared to receive inputs from the codec 344. In one embodiment, voice commands may not be processed by the speech processor 340 at 402. The speech processor 340, as an example can be, but is not limited to being a DSPIC306014 made by Microchip Technology Inc. of Chandler, Ariz. The command processor 310, as an example can be, but is not limited to being a DSPIC306014A made by Microchip Technology Inc.

At 410, the speech processor 340 can wait to receive input from the codec 344 so that it can determine the operational mode that will be selected. An example codec 344 can be, but is not limited to being a SI3000 made by Silicon Laboratories of Austin, Tex. The codec 344 can receive analog sound waves that can be captured by the microphone 346. The codec 344 can convert the analog sound waves to a digitally encoded version and can send the encoded information to the speech processor 340. In another embodiment, the microphone 346 could have a digital output send data directly to the speech processor 340.

At 410, either manual/automatic mode 430 or smooth humming mode 420 can be selected. A user can select the manual/automatic mode 430 that may allow the user to command the wheel chair 334 to go in a direction at a preset speed or select from a number of speed settings. A user can also select smooth humming mode 420 that may allow the user to command the wheel chair 334 to go at a speed that can correspond to the frequency of a hum made by the user. One example of how the user can select a mode will be explained later.

At 410, the speech processor 340 may only respond to certain programmed key command words. A key command word can be a word that can be spoken by the user that can indicate that the user wants to control the wheel chair 334. The user may not want the wheel chair system 300 to respond to a command word or frequency if the word or frequency was used in conversation and not meant to control or issue a command to the wheel chair 334. Thus, the speech processor may only respond and have the wheel chair system 300 prepare to send commands to the wheel chair 334 if a certain key command word is received first. A few examples of key command words that may be recognized at 410 are “stop”, “control”, and “go”. These key command words will be explained in turn.

The “stop” command word can be given any time during the wheel chair command process 400. When the speech processor 340 recognizes that the “stop” command word has been spoken, it can communicate to the command processor 310 that it has received a stop command. The command processor 310 can then send a command to the wheel chair controller 330 to stop the wheel chair 334. In addition, the wheel chair command process 400 may begin again at 402.

The “control” command word can be given any time during the wheel chair command process 400. The process 400 can move to 420 when the speech processor 340 recognizes the receipt of the “control” key command word. For example, at 420, the command processor 310 may send a command to the wheel chair controller 330 to stop the wheel chair 334 so that the wheel chair 334 can prepare to receive addition commands from the user. The wheel chair command process 400 can then proceed to 422. The “control” command word may be used as a key command word to enter smooth humming mode 420.

For example, the wheel chair 334 can be traveling at a speed in any direction and the user can say the word “control”. The speech processor 340 can recognize the word “control” as a key command word. The speech processor 340 can indicate to the command processor 310 that the control command word has been received. The command processor 310 can then send a command to the wheel chair controller 330 to stop the wheel chair 334. The wheel chair 334 can then come to a stop. After receiving the “control” command word, the speech processor 340 can wait to receive additional commands from the user that can be recognized after entering the smooth humming mode 420. However, alternative embodiments may allow the wheel chair to move from one command to another without stopping. For example a second command could direct the wheel chair to speed up or turn without stopping.

The “go” command word may be given during the wheel chair command process 400. The process 400 can move to 430 when the speech processor 340 recognizes the receipt of the “go” key command word. At 430, the command processor 310 can send a command to the wheel chair controller 330 to stop the wheel chair 334. The wheel chair command process 400 can then proceed to 432. The “go” command word can be the key command to enter manual/automatic mode 430.

For example, the wheel chair 334 can be traveling at a speed in any direction and the user can say the word “go”. The speech processor 340 can recognize the word “go” as a key command word. The speech processor 340 can indicate to the command processor 310 that the control key command word has been received. The command processor 310 can then send a key command to the wheel chair controller 330 to stop the wheel chair 334. The wheel chair 334 can then come to a stop. After receiving the “go” command word, the speech processor 340 can wait to receive additional key commands from the user that can be recognized after entering the enter manual/automatic mode 420.

Once the command process 400 has entered the smooth humming mode 420 and the wheel chair 334 has stopped, the speech processor 340 can await a direction key command word at 422. At 422, the speech processor 340 can wait until a direction key command word is spoken by the user and received by the speech processor 340. The direction key command words can indicate the direction that the wheel chair 334 can travel. In one embodiment, four direction commands words can be recognized at 422. Examples of direction key commands word include: “forward”, “backward”, “right” and “left”. Once the speech processor 340 recognizes one of these direction key commands words, it can indicate to the command processor 310 the direction key command received. The command process 400 can proceed to 426.

In one embodiment, a limited amount of time can be given after receiving a key command word before the speech processor 340 may not recognize a direction key command word. In this embodiment, if no direction key command is received within the set amount of time, the command process 400 can return to 410 and can await another key command. For example, the time limit could be ten seconds and the user could say the key command word “control” and then wait fifteen seconds before saying “left”. In this instance, the speech processor 340 may not recognize the word “left” as a direction command word because it was not spoken within the time limit.

At 426, the command processor 310 can wait to receive data from the accelerometer 320 so that the command processor 310 can determine the speed command that can be spent to the wheel chair 334. In this embodiment, the accelerometer 320 can be, but is not limited to being, a MMA1260EG made by Free Scale Semiconductor, Inc. of Austin Tex. The accelerometer 320 can be attached to the throat of a user operating the wheel chair 334. The accelerometer 320 can detect the frequency of a hum produced by a user and can send a corresponding digital and/or analog signal to the command processor 310. The command processor 310 can receive the digital and/or analog signal and through a process can calculate the frequency of the sound waves that caused the accelerometer to vibrate. Such a process may include the use of a Fast Fourier Transform (FFT). Once the frequency of the hum is calculated, the frequency can be sorted into one of several (e.g., six) preset frequency ranges and the range in which the received frequency is found can be selected.

For example, a user could hum at a frequency of 225 Hz. The accelerometer 320 could detect the frequency and could send a digital signal to the command processor 310. The command processor 310 could use an FFT to correlate the digital signal to a frequency of 225 Hz. The command processor 310 could also have 5 frequency ranges. The ranges could be from 10-100 Hz, 100-150 Hz, 150-200 Hz, 200-300 Hz and 300-350 Hz, for example. In this instance, the frequency could be sorted into the 200-300 Hz range and this range could be selected.

Subsequently, a speed command that can correspond to the selected frequency range can be calculated. The speed command can indicate the speed at which the wheelchair 334 can move. The calculated speed command along with the direction command can then be sent to the wheel chair controller 330 in analog and/or digital form. The preset frequency ranges in the command processor 310 can vary and can be large or small. For example, a preset range could be from 50 to 150 Hz while another could be from 150 to 450 Hz. Alternatively, each different frequency rounded to the whole frequency could correspond to a different range and thus a different speed command.

In this embodiment, lower frequencies ranges can correspond to lower speeds and higher frequency ranges can correspond to higher speeds. If no frequency is received by the command processor 310 then the wheel chair 334 may not move. At 440, a calculated speed and direction can be sent to the wheel chair controller 330. The wheel chair 334 can move at the speed corresponding to the received humming frequency until a frequency that corresponded to another speed can be received, processed and sent to the wheel chair controller 330. Thus, a frequency that can be detected by the accelerometer 320 can determine the speed of the wheel chair 334.

For example, a user can hum at 250 Hz which could cause the wheel chair 334 to travel at a pace that could be 1/10th of the maximum speed of the wheel chair. The user could then hum at 350 Hz. This frequency could fall within a frequency region that may not include 250 Hz and could correspond to another speed. Thus, a different speed command could be selected and sent to the wheel chair 334. The wheel chair 334 could then travel at a pace that could be ⅕th of the maximum speed of the wheel chair.

In another embodiment, when the command process 400 is at 426 the wheel chair 334 can move in the command direction at a predetermined speed. Any received humming frequency can cause the command processor 310 to increase the predetermined speed of the wheel chair 334. The command process 400 can continue to select a speed based on frequency at 426 and can send the command to the wheel chair controller 330 at 440 until a key command word is received by the speech processor as 410.

At 410, if the received key command word is the “go” command word, the command process 400 can proceed to 430 and enter the Manual/Automatic mode. At 432, the speech processor 340 can wait until a direction key command word is spoken by the user and received by the speech processor 340. The direction key command words can indicate the direction that the wheel chair 334 can travel. For example, in one embodiment, four direction commands words can be recognized at 422. The direction commands word can be “forward”, “backward”, “right” and “left”. Once the speech processor 340 recognizes one of the four direction key commands words, the speech processor 340 can indicate to the command processor 310 the direction key command received. The command process 400 can proceed to 434.

In one embodiment, a limited amount of time can be given after receiving a key command word before the speech processor 340 does not recognize a direction command word. In this embodiment, if no direction command is received within the set amount of time, the command process 400 can return to 410 and await another key command. For example, the time limit could be ten seconds and the user could say the key command word “control” and then wait fifteen seconds before saying “left”. In this instance, the speech processor 340 may not recognize the word “left” as a direction command word because it was not spoken within the time limit. The direction command words in the manual/automatic mode may be identical and may function the same way as those direction command words in the smooth humming mode.

Once a direction command word has been received by the speech processor 340, the command process 400 can proceed to 434. At 434, the command processor 310 can send the preset speed of one, and the direction command received at 432, to the wheel chair controller 330. For example, the user could say the command word “go” and then could say “left”. The wheel chair controller 330 could then send a command at 440 to the wheel chair 334 that could cause the wheel chair 334 to go left from its current position at the speed equal to the preset speed of one. In another embodiment, there can be no preset speed and the command processor 310 can wait to receive a speed command from the speech processor 340.

At 434, the speech processor 340 can wait to receive a “speed” command word from the user. Once the user says the word “speed”, the speech processor 340 can recognize the speed command word and can wait for the user to say a speed number command word. In this embodiment, the word “speed” acts like a key command word for various speed number command words. Thus, the speech processor may not recognize speed number command words, unless the “speed” command word is first recognized. In one embodiment, the speed number command words can be “one”, “two”, “three” and four”. The speed number command words can correlate to four different speeds at which the wheel chair 334 could travel. Speed number command word “one” could allow the wheel chair 334 to travel at 25% of the maximum speed. Speed number command word “two” could allow the wheel chair 334 to travel at 50% of the maximum speed. Speed number command word “three” could allow the wheel chair 334 to travel at 75% of the maximum speed and speed number command word “four” could allow the wheel chair 334 to travel at maximum speed.

Once the speech processor 340 recognizes a speed number command word, it can indicate to the command processor 310 the speed number command word received. The command processor 310 can send a command to the wheel chair controller 330 at 440 that could include a direction command and a speed command that can correspond to the speed number command word received. The wheel chair controller 330 could then have the wheel chair 334 move in the command direction at the command speed. Further, additional speed command words and speed number command words can be recognized and new speed commands that can correspond to the recognized speed number command words can be sent to the wheel chair 334 at 440 to change the speed of the wheel chair 334.

For example, in 432 the user could say “left” and then at 434 the user could say “speed two”. The wheel chair 334 could move the left at a speed of 50% of the maximum wheel chair speed. The user could then say “speed three”. The wheel chair could then increase its speed to 75% of its maximum speed.

An example of the command process 400 is set forth below, and should not be limiting in any way. At 402, the speech processor 340 can run a self test. At 410, the user can say the word “control”; the word can be captured by the microphone 346, converted to digital by the codec 344 and sent to the speech processor 340. The speech processor 340 can recognize the word “control” as a command word and enter the smooth humming mode at 420. At 422, the user can say the word “forward”; the word can be captured by the microphone 346, converted by the codec 344 and sent to the speech processor 340. The speech processor 340 can recognize the word “forward” as a command word and indicate to the command processor 310 that the direction can be forward and that the command process 400 can be in the smoothing humming mode.

At 422, the accelerometer 320 can detect the frequency of the hum produced by the user and can send an analog and/or digital signal encoded with the frequency to the command processor 310. At 426, the command processor 310 can determine the frequency and the corresponding frequency range. The command processor 310 can calculate the speed corresponding to the frequency range and, at 440, can send the selected speed and direction to the wheel chair controller 330. The wheel chair 334 can respond to the wheel chair controller 330 and can move forward at the calculated speed.

The user can then hum at a higher frequency that can be detected by the accelerometer 320. The command processor 310 can then repeat 426 and can determine a new speed if the higher frequency falls within a different range than the previous frequency. At 440, if a new speed is determined, the new speed can be sent to the wheel chair controller 330 and the speed of the wheel chair 334 can be increased. Unlike the several discrete speeds available in the manual/automatic mode, the smooth humming mode can have numerous speed settings depending on the number of frequency ranges used to determine speed.

During the command process 400, the command processor 310 can receive data from various sensors 324. The sensors can be located on the wheel chair 334 and can provide feedback to the command processor 310 so that it can be a closed loop system. Further, the sensors 324 can provide the command processor 310 with data about obstacles in the path of the wheel chair 334 so that the command processor 310 can stop the wheel chair 334 before the wheel chair 334 can collide with foreign objects.

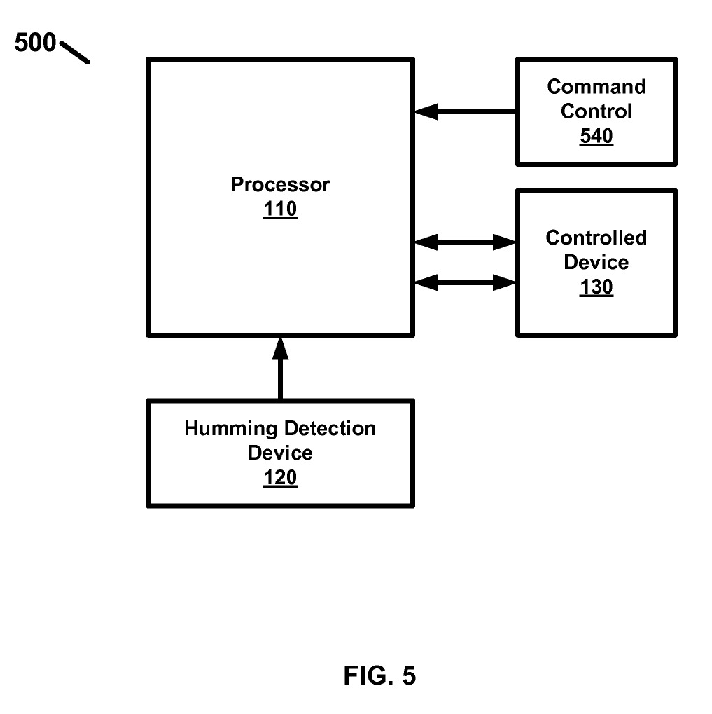

FIG. 5 shows a command system 500 that can be controlled by the frequency of a hum and additional command controls, according to one embodiment. The command system 500 includes a processor 110, a humming detecting device 120, a controlled device 130 and a command controller 540. The processor 110 can be coupled to the humming detection device 120, the command controller 540 and the controlled device 130. The processor 110 can receive digital and/or analog signals from the humming detecting device 120, the command controller 540 and the controlled device 130. The processor 110 can send digital and/or analog signals to the controlled device 130.

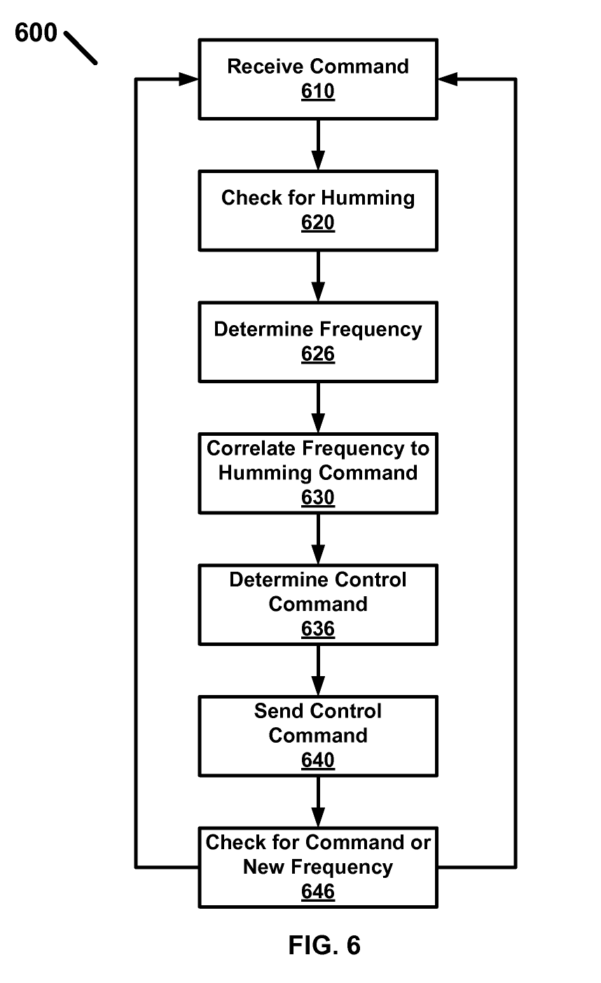

FIG. 6 shows a command process 600 that can control a system using the frequency of a hum and additional controls, according to one embodiment. At 610, the processor 110 can receive a command from the command controller 540. The command from the command controller 540 can be provided by a user using a technique, such as, but not limited to, speech, keyboard, GUI interface, change in pressure, change in air speed, key pad, eye movement, tongue movement, head movement, or other body movement. The user can input the command into a device that communicates with the command controller 540 via a hardwire connection or a wireless connection or the user can input commands into the command controller 540 directly.

The command received at 610 can be processed by the processor 110. The received command can indicate that the processor 110 check for humming by using the humming detecting device 120. Further, the received command may, indicate for the processor to be idle, included additional instructions to accompany a command generated from the received humming frequency, or be a command to send directly to the controlled device 130. At 620, the processor 110 can receive digital and/or analog signals from the humming detection device 120 that corresponds to the frequency of the hum that the humming detection device 120 detected. The humming detection device 120 can be an accelerometer in this embodiment. However, the humming detection device 120 may be a microphone, either dynamic or condenser type, or any other acquisition device which allows one to measure frequency or vibration.

At 626, the processor 110 can calculate the frequency of the hum from the digital and/or analog signal received from the humming detection device 120. At 630, the processor 110 can correlate the frequency determined at 626 to a humming command. Every humming command can correspond to a predetermined range of frequencies. The humming command selected can correspond to the range of frequencies that contains the calculated frequency. For example, a range of frequencies can vary from one hertz to thousands of hertz. In another embodiment, the humming command can be determined based on a sequence of received frequencies.

At 636, the processor 110 can determine a control command based on the humming command alone or in combination with the command received from the command controller 540 at 610. For example, the received command could indicate a direction and the humming command could indicate a speed. At 640, the control command can be sent to the controlled device 130. At 646, the processor 110 can check for new commands from the command controller 540 unless previously received commands or humming commands indicate other action is required. For example, a received command can indicate for the processor 110 to continue to check for new frequencies at 646 and once a new frequency or sequence of frequencies is received, processes 626, 630, 636, and 640 could be performed. The process could continue until a humming command or received command indicated other action.

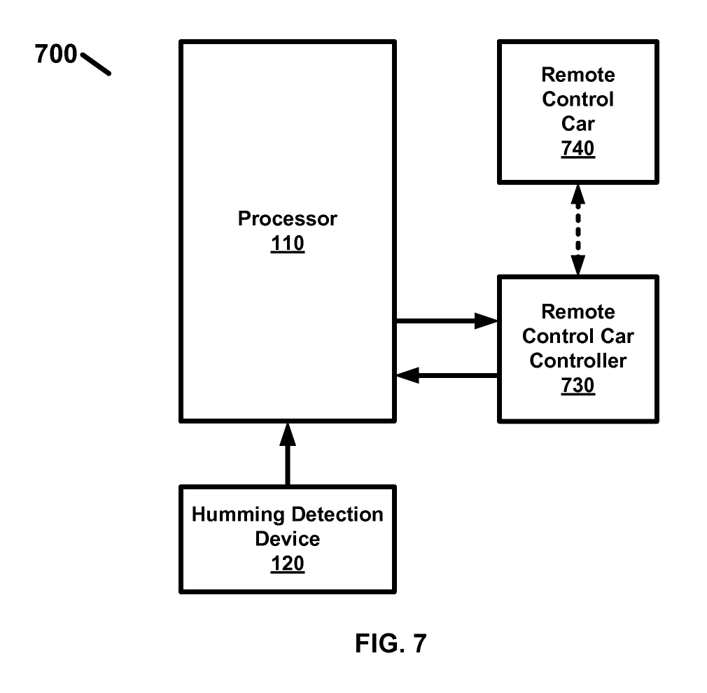

The embodiments set forth above can be used to describe various systems. FIG. 7 shows an example remote control car system 700 that can control a remote control car using the frequency of a hum, according to one embodiment. The car system 700 includes a processor 110, a humming detection device 120, a remote control car controller 730, and a remote control car 740. The processor 110 can be connected to the humming detection device 120 and the remote control car controller 730 and can receive digital and/or analog signals from both. The processor 110 can also send digital and/or analog signals to the remote control car controller 730. The remote control car controller 730 can be coupled to and can send digital and/or analog signals to the remote control car 740.

The remote control car controller 730 can control the direction of the remote control car 740. The remote control car's 740 speed may be controlled by the frequency of the hum received by the humming detecting device 120. Once the car controller 730 is turned on, the processor 110 can be activated and checks for inputs from the humming detecting device 120. The humming detecting device 120 can receive a frequency of a hum and can send a signal to the processor 110. The processor 110 can determine the frequency and can correlate the frequency to a speed setting as previously described. The speed setting can then be sent to the car controller 730. The car controller 730 can then relay the speed setting to the remote control car 740 which can then travel at that speed and the direction indicated by the car controller 730. As described earlier in this disclosure, commands may be a combination of key commands and humming commands. Key commands may be generated by the remote control car controller after receiving data from alternative sources such as joy sticks, keyboards, switches etc.

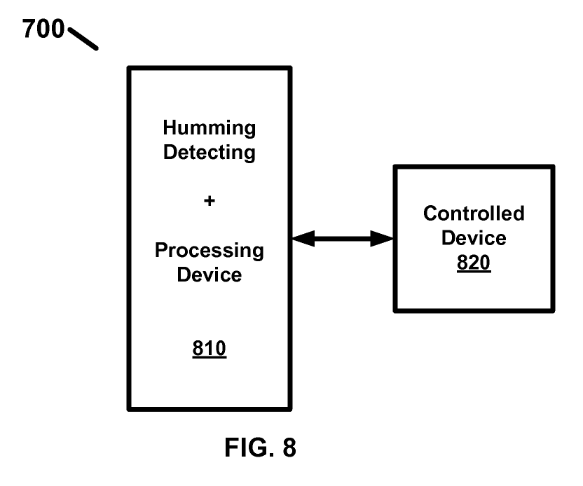

The embodiments set forth above can further be implemented with a reduced chip count. For example, FIG. 8 shows a compact system 800 that can be controlled by the frequency of a hum, according to one embodiment. The compact system 800 includes a humming detecting and processing device 810 and a controlled device 820. The humming device 810 can be coupled to and can send digital and/or analog signals to the controlled device 820. The humming device 810 can detect humming and can determine the frequency of the humming. Further, the humming device 810 can correlate a command based upon the received humming frequency or received sequence of humming frequencies. The humming device 810 can send the command to the controlled system 820 who executes the command.

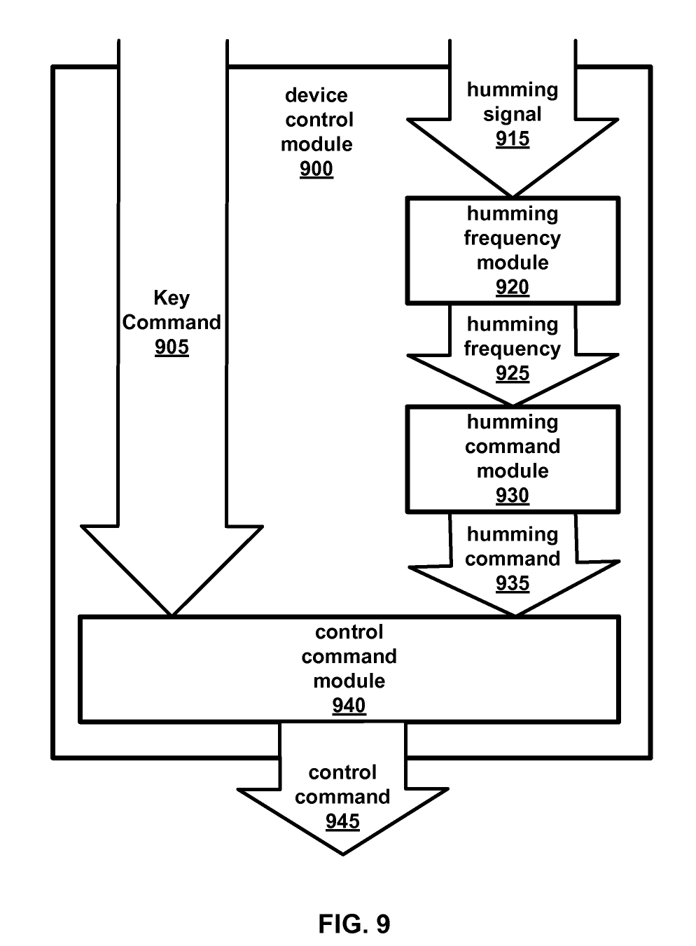

FIG. 9 shows an apparatus for controlling a device 900 as per an aspect of an embodiment. As shown, the apparatus for controlling a device 900 includes: a humming frequency module 920, a humming command module 930, and a control command module 940. The humming frequency module 920 may be configured to determine humming frequenc(ies) 925 using a detected humming signal(s) 915. The humming command module 930 may be configured to compute humming command(s) 935 based on the humming frequenc(ies) 925. The control command module 940 may be configured to generate control command(s) 945 using received key command(s) 905 and humming command(s) 935.

Humming signal(s) 915 may be an analog signal and/or a digital signal. Humming signal(s) may be derived using an accelerometer, a microphone or the like.

Humming command(s) 935 may represent an absolute velocity, a relative change in velocity, a rate of change of velocity or the like. For example, where the controlled device is a display, the humming command could also represent an absolute brightness, a relative change in brightness, a rate of change in brightness or the like. Similarly, humming command(s) 935 may represent variations in direction.

Key command(s) 905 may be derived using a speech recognition system or the like. Key command(s) 905 may be a direction, a velocity, movement, or the like.

The apparatus for controlling a device 900 may be a remote control apparatus for controlling devices. The controlled device may be a wheelchair, a remote control toy, a robot, an autonomous instrument, or the like.

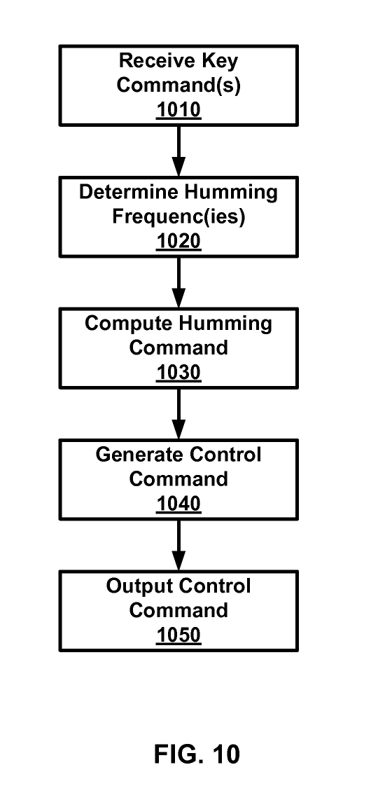

FIG. 10 shows a flow diagram of a method for controlling a device as per an aspect of an embodiment. The method may be executable by at least one suitably programmed processor for controlling the device. The method may include: receiving key command(s) 1010; determining humming frequenc(ies) 1020 using detected humming signal(s); computing humming command(s) 1030 based on humming frequenc(ies) 1020; generating control command(s) 1040 using key command(s) 1010 and humming command(s) 1030; and outputting control command(s) 1050.

Humming signal(s) may be detected using accelerometer(s), microphone(s), piezo electric crystal(s), other sound detection device(s) or a combination of the above.

Key command(s) may be derived from speech. Key command(s) may include direction(s), velocity(ies), intensity(ies) or the like.

The suitably programmed processor for controlling a device may be a remote suitably programmed processor for controlling a device.

Humming command(s) may represents absolute velocity(ies), relative velocity(ies), changes in rate of velocity(ies), absolute direction(s), relative direction(s), changes in rate of direction(s) etc.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described embodiments. In particular, it should be noted that, for example purposes, the above explanation has focused on the examples of a wheel chair and a remote control car. However, one skilled in the art will recognize that various embodiments could be other uses such as for a video game controller or a robotics controller.

In addition, it should be understood that any figures which highlight the functionality and advantages, are presented for example purposes only. The disclosed architecture is sufficiently flexible and configurable, such that it may be utilized in ways other than that shown. For example, the procedures listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

It is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

It is understood that the invention is not limited to the particular methodology, protocols, topologies, etc., as described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein.

Any numerical values recited herein include all values from the lower value to the upper value in increments of one unit provided that there is a separation of at least two units between any lower value and any higher value. As an example, if it is stated that the concentration of a component or value of a process variable such as, for example, size, angle size, pressure, time and the like, is, for example, from 1 to 90, specifically from 20 to 80, more specifically from 30 to 70, it is intended that values such as 15 to 85, 22 to 68, 43 to 51, 30 to 32 etc., are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Particular methods, devices, and materials are described, although any methods and materials similar or equivalent to those described herein can be used in the practice or testing of the invention. All references referred to herein are incorporated by reference herein in their entirety.

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e. hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

What is claimed is:

1. An apparatus for controlling a device comprising:
a) a humming frequency module configured to determine at least one humming frequency using a detected humming signal;
b) a humming command module configured to compute at least one humming command based on the at least one humming frequency;
c) a control command module configured to generate at least one control command using:
i) at least one received key command; and
ii) the at least one humming command; and
d) an output module configured to output at least one control command.

2. The apparatus of claim 1, wherein at least one of the at least one humming signal is at least one of the following:
a) an analog signal; or
b) a digital signal.

3. The apparatus of claim 1, wherein at least one of the at least one humming signal is derived using an accelerometer.

4. The apparatus of claim 1, wherein at least one of the at least one humming signal is derived using a microphone.

5. The apparatus of claim 1, wherein the controlled device is a wheelchair.

6. The apparatus of claim 1, wherein the controlled device is a remote control toy.

7. The apparatus of claim 1, wherein at least one of the at least one key command is derived using a speech recognition system.

8. The apparatus of claim 1, wherein at least one of the at least one key command is a direction.

9. The apparatus of claim 1, wherein the apparatus for controlling a device is a remote control apparatus for controlling a device.

10. The apparatus of claim 1, wherein at least one of the at least one humming command represents an absolute velocity.

11. The apparatus of claim 1, wherein at least one of the at least one humming command represents a relative change in velocity.

12. The apparatus of claim 1, wherein at least one of the at least one humming command represents a relative change in direction.

13. A method executable by at least one suitably programmed processor for controlling a device comprising:
a) receiving at least one key command;
b) determining at least one humming frequency using at least one detected humming signal;
c) computing at least one humming command based on the at least one humming frequency;
d) generating at least one control command using:
i) the at least one key command; and
ii) the at least one humming command; and
e) outputting at least one control command.

14. The method of claim 13, wherein at least one of the at least one humming signal is detected using at least one of the following:
a) an accelerometer;
b) a microphone;
c) a sound detection device;
d) a piezo electric crystal; or
e) a combination of the above;

15. The method of claim 13, wherein at least one of the at least one key command is derived from speech.

16. The method of claim 13, wherein at least one of the at least one suitably programmed processor for controlling a device is a remote suitably programmed processor for controlling a device.

17. The method of claim 13, wherein at least one of the at least one key command includes a direction.

18. The method of claim 13, wherein at least one of the at least one humming command represents a relative change in direction.

19. The method of claim 13, wherein at least one of the at least one humming command represents an absolute velocity.

20. The method of claim 13, wherein at least one of the at least one humming command represents a relative change in velocity.
